(19) United States
(12) Patent Application Publication
(10) Pub. No.: US 2018/0283047 A1
(43) Pub. Date: Oct. 4, 2018

(54) LOCK KNOB ASSEMBLY

(71) Applicant: TAIWAN FU HSING INDUSTRIAL CO., LTD., Kaohsiung City (TW)

(72) Inventors: Lien-Hsi Huang, Kaohsiung City (TW); Wen-Chieh Lee, Kaohsiung City (TW); Fu-Chih Huang, Kaohsiung City (TW)

(21) Appl. No.: 15/597,340

(22) Filed: May 17, 2017

(30) Foreign Application Priority Data
Mar. 29, 2017 (TW) 106204432

(51) Int. Cl. E05B 17/14; E05B 1/00; E05B 63/00

(52) U.S. Cl. CPC E05B 17/142; E05B 63/0056; E05B 63/0043; E05B 1/0015

(57) ABSTRACT

A lock knob assembly includes a knob body, a cover and a coupling member. The knob body is provided for covering a lock cylinder, and the cover is provided for covering the knob body. The lock knob assembly utilizes the coupling member to selectively couple the cover and the knob body, thus allowing the cover to couple with or separate from the knob body.

### FIELD OF THE INVENTION

This invention relates to a lock knob assembly, and more particularly relates to a lock knob assembly utilizing a coupling member to selectively couple a knob body and a cover.

### BACKGROUND OF THE INVENTION

Taiwan patent publication No. 274574 (application No. 084103636) discloses an auxiliary lock which utilizes an exterior free rotating cylinder guard 12 to cover a cylinder and then utilizes a cover 14 to cover the exterior free rotating cylinder guard 12. The exterior free rotating cylinder guard 12 and the cover 14 both include an opening for revealing the key hole of the cylinder. The cover 14 is not fixed when covering the exterior free rotating cylinder guard 12, so it is easy to fall down from the exterior free rotating cylinder guard 12.

### SUMMARY

The primary object of the present invention is to provide a lock knob assembly which utilizes a coupling member to couple a knob body and a cover, thus preventing the cover from separating from the knob body.

The lock knob assembly of the present application comprises a knob body, a cover and a coupling member, wherein the knob body is utilized to cover a lock cylinder, the cover is utilized to cover the knob body, and the coupling member is selectively located at a first position and a second position. The cover is capable of separating from the knob body when the coupling member is located at the first position, and the cover is coupled with the knob body by the coupling member when the coupling member is located at the second position.

### DESCRIPTION OF THE DRAWINGS

FIG. 1 is a perspective assembly diagram illustrating a lock knob assembly in accordance with a first embodiment of the present invention.

FIG. 2 is a perspective exploded diagram illustrating the lock knob assembly in accordance with the first embodiment of the present invention.

FIG. 3 is a cross-section view diagram illustrating the lock knob assembly in accordance with the first embodiment of the present invention.

FIG. 4 is a cross-section view diagram illustrating the lock knob assembly in accordance with the first embodiment of the present invention.

FIG. 5 is a cross-section view diagram illustrating a lock knob assembly in accordance with a second embodiment of the present invention.

FIG. 6 is a cross-section view diagram illustrating the lock knob assembly in accordance with the second embodiment of the present invention.

### DETAILED DESCRIPTION OF THE INVENTION

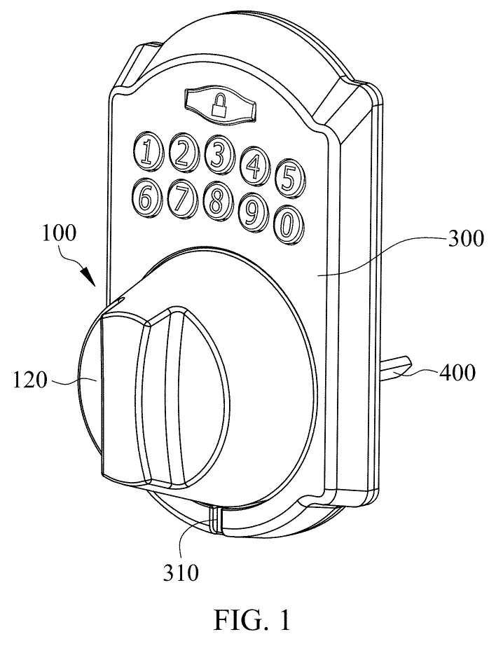

With reference to FIGS. 1 to 4, a lock knob assembly 100 in accordance with a first embodiment of the present invention can be, but not limited to, mounted on a door or a lock escutcheon 300.

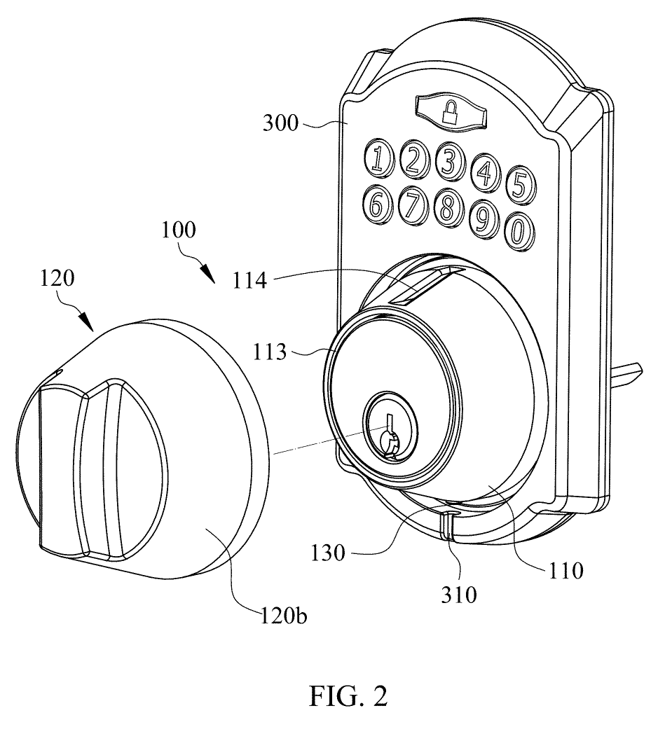

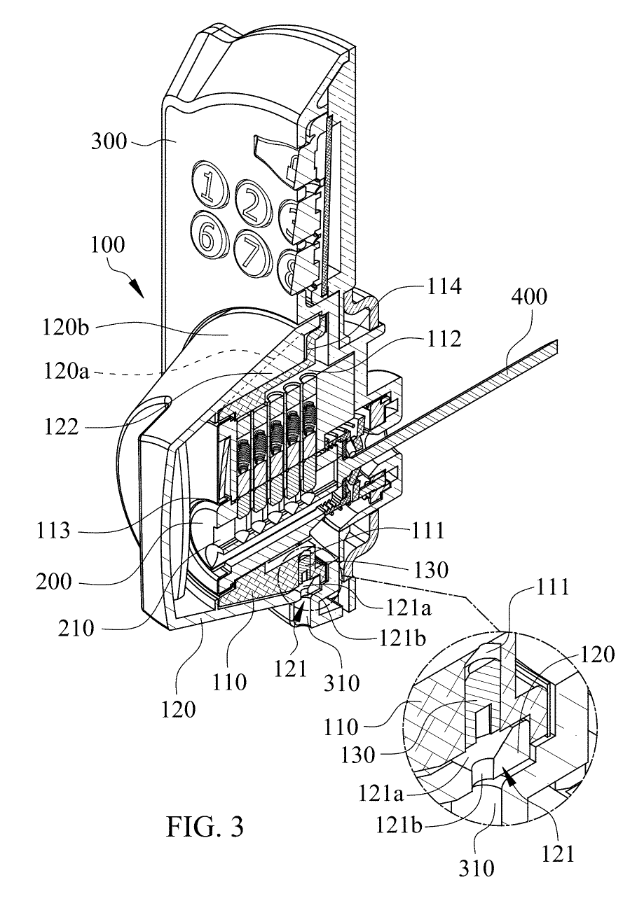

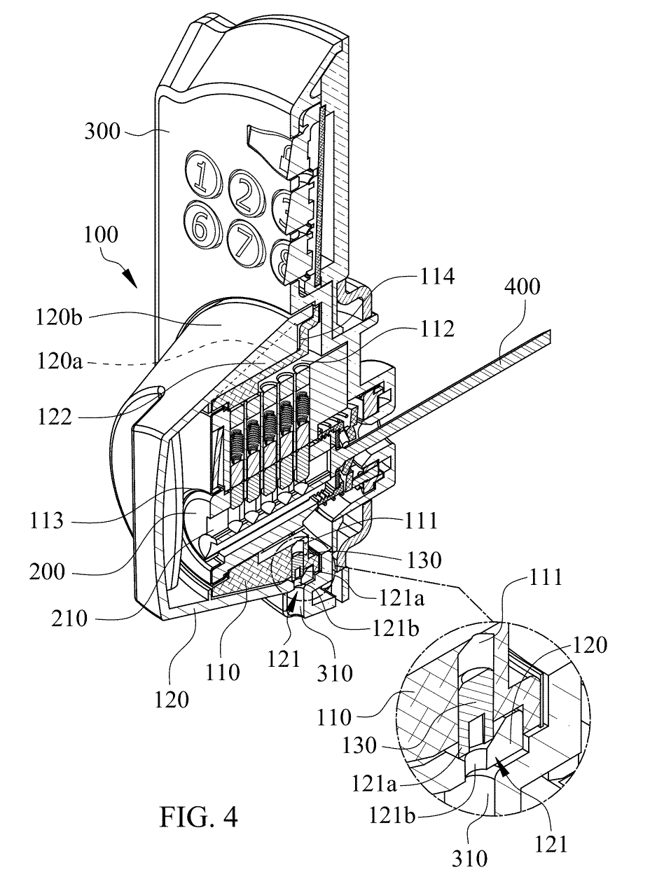

With reference to FIGS. 2 and 3, the lock knob assembly 100 comprises a knob body 110, a cover 120 and a coupling member 130, wherein the cover 120 is adapted to cover the knob body 110. With reference to FIGS. 1, 2 and 3, the lock knob assembly 100 is mounted on the lock escutcheon 300 in the first embodiment, wherein the lock escutcheon 300 is adapted to cover a lock cylinder 200, and the lock cylinder 200 is coupled with a spindle 400 for driving a latch bolt (not shown) to operate. With reference to FIGS. 3 and 4, the coupling member 130 is selectively located at a first position (FIG. 3) and a second position (FIG. 4).

With reference to FIG. 3, the cover 120 is capable of separating from the knob body 110 while the coupling member 130 is located at the first position. In the first embodiment, the knob body 110 includes a first hole 111, the cover 120 includes a second hole 121, and the coupling member 130, which is located at the first position, is located in the first hole 111. The coupling member 130 located in the first hole 111 allows the cover 120 to separate from the knob body 110 without the limitation of the coupling member 130. With reference to FIG. 4, when the coupling member 130 is located at the second position, the cover 120 is coupled with the knob body 110 by the coupling member 130. For this reason, the cover 120, which can not separate from the knob body 110 because of the limitation of the coupling member 130, is capable of driving the knob body 110 in rotation. In the first embodiment, the coupling member 130, which is located at the second position, is located in the first hole 111 and the second hole 121 simultaneously.

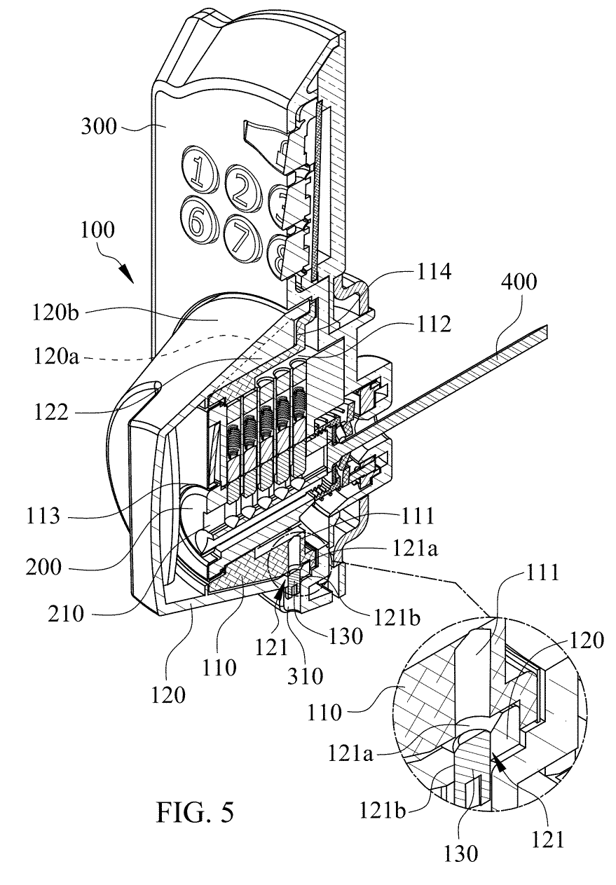

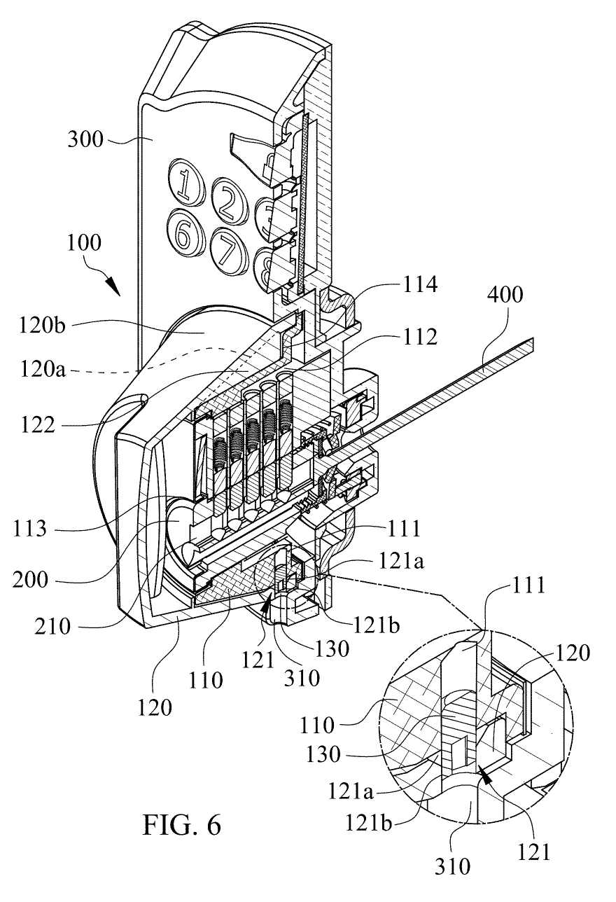

A second embodiment of the present invention is illustrated in FIGS. 5 and 6. With reference to FIG. 5, the first position in the second embodiment means the coupling member 130 is located in the second hole 121, wherein the cover 120 is not coupled with the knob body 110 through the coupling member 130, hence the cover 120 is capable of separating from the knob body 110. With reference to FIG. 6, the second position in the second embodiment means the coupling member 130 is located in the first hole 111 and the second hole 121 simultaneously, so the cover 120, which is coupled with the knob body 110 by the coupling member 130, can not separate from the knob body 110.

With reference to FIG. 3 or 4, the knob body 110 of the present invention further includes an accommodation space 112 and a opening 113 which communicates with the accommodation space 112, wherein the accommodation space 112 and the opening 113 are respectively adapted to accommodate and reveal the lock cylinder 200, and the cover 120 covers the lock cylinder 200.

With reference to FIG. 3 or 4, the first hole 111 and the coupling member 130 of the present invention are, respectively, a tapped hole and a screw. The cover 120 includes an internal surface 120a and an external surface 120b, and the second hole 121 includes an accommodation hole 121a and a tool-operated hole 121b which communicates with the accommodation hole 121a, wherein the accommodation hole 121a is recessed from the internal surface 120a of the cover 120 for accommodating the coupling member 130, and the tool-operated hole 121b is recessed from the external surface 120b of the cover 120 for passing of a tool (not shown) which is utilized for moving the coupling member 130 to the first or second position. Preferably, the accommodation hole 121a is not smaller in internal diameter than the tool-operated hole 121.b, thus preventing the falling down of the coupling member 130. The lock escutcheon 300 preferably includes an opening hole 310 which corresponds to the second hole 121, wherein the opening hole 310 is provided for passing of the tool, and for the operator to operate the tool to move the coupling member 130 located in the second hole 121.

With reference to FIG. 3 or 4, the knob body 110 of the present invention includes a restriction groove 114 which is recessed into the knob body 110, and the cover 120 includes a restriction flange 122 which is located in the restriction groove 114. Preferably, the restriction groove 114 and the first hole 111 are symmetrically located on the knob body 110, and the restriction flange 122 and the second hole 121 are symmetrically located on the cover 120, hence the coupling strength between the cover 120 and the knob body 110 can be improved when the cover 120 is coupled with the knob body 110 by the coupling member 130.

With reference to FIGS. 4 and 6, the lock knob assembly 100 of the present invention utilizes the coupling member 130 to couple the knob body 110 and the cover 120 for preventing the cover 120 from separating from the knob body 110. With reference to FIGS. 3 and 5, when the coupling member 130 is not located in the knob body 110 and the cover 120 simultaneously, the cover 120 is free (without the limitation of the coupling member 130), and is capable of being removed for installing another cover 120, or being removed for revealing a key hole 210 of the lock cylinder 200 for a key (not shown) to drive the lock cylinder 200 and the spindle 400.

While this invention has been particularly illustrated and described in detail with respect to the preferred embodiments thereof, it will be clearly understood by those skilled in the art that is not limited to the specific features shown and described, and various modification and change in form and details may be made without departing from the spirit and scope of this invention.

1. A lock knob assembly mounted on a lock having a lock cylinder, the lock knob assembly comprising:
a knob body covering only a portion of the lock cylinder;
a cover covering the knob body; and
a coupling member movable between a first position separating the cover from the knob body and preventing the coupling member from falling out of the lock knob assembly and a second position coupling the cover with the knob body.

2. The lock knob assembly in accordance with claim 1, wherein the knob body includes a first hole, the cover includes a second hole, the coupling member, located at the first position, is selectively located in one of the first and second holes, the coupling member located at the second position is located in the first and second holes simultaneously, and wherein the cover and the knob body rotate together when the coupling member is located at the second position.

3. The lock knob assembly in accordance with claim 2, wherein the knob body further includes an accommodation space and an opening which communicates with the accommodation space, the accommodation space accommodates the lock cylinder, the opening reveals the lock cylinder, and wherein the cover covers the lock cylinder.

4. The lock knob assembly in accordance with claim 2, wherein the cover includes an internal surface and an external surface, and the second hole includes an accommodation hole and a tool-operated hole which communicates with the accommodation hole, and wherein the accommodation hole is recessed from the internal surface of the cover for accommodating the coupling member, and the tool-operated hole is recessed from the external surface of the cover for passing of a tool to move the coupling member.

5. The lock knob assembly in accordance with claim 4, wherein the accommodation hole is not smaller in internal diameter than the tool-operated hole.

6. The lock knob assembly in accordance with claim 3, wherein the cover includes an internal surface and an external surface, and the second hole includes an accommodation hole and a tool-operated hole which communicates with the accommodation hole, and wherein the accommodation hole is recessed from the internal surface of the cover for accommodating the coupling member, and the tool-operated hole is recessed from the external surface of the cover for passing of a tool to move the coupling member.

7. The lock knob assembly in accordance with claim 6, wherein the accommodation hole is not smaller in internal diameter than the tool-operated hole.

8. The lock knob assembly in accordance with claim 2, wherein the first hole is a tapped hole and the coupling member is a screw.

9. The lock knob assembly in accordance with claim 2, wherein the knob body includes a restriction groove which is recessed into the knob body, and the cover includes a restriction flange which is located in the restriction groove.

10. The lock knob assembly in accordance with claim 9, wherein the restriction groove and the first hole are located diametrically apart from one another and the restriction flange and the second hole are located diametrically apart from one another on the cover.

11. (canceled)

12. A lock knob assembly mounted on a lock having a lock escutcheon and a lock cylinder, the lock knob assembly comprising:
a knob body mounted on the lock escutcheon and covering only a portion of the lock cylinder;
a cover covering the knob body; and
a coupling member movable between a first position separating the cover from the knob body and a second position coupling the cover to the knob body, wherein the coupling member, located at the first position, is prevented from falling out of the lock knob assembly, the coupling member, located at the second position, is located in a first hole of the knob body and a second hole of the cover simultaneously, the second hole is aligned with an opening hole of the lock escutcheon, and the coupling member, located at the first position, is located in one of the first hole, the second hole, and the opening hole.

13. A lock knob assembly mounted on a lock having a lock escutcheon, the lock knob assembly comprising:
a knob body mounted on the lock escutcheon;
a cover covering the knob body; and
a coupling member movable between a first position separating the cover from the knob body and a second position coupling the cover to the knob body, wherein the coupling member, located at the first position, is prevented from falling out of the lock knob assembly, the coupling member, located at the second position, is located in a first hole of the knob body and a second hole of the cover simultaneously, the second hole is aligned with an opening hole of the lock escutcheon, and the coupling member, located at the first position, is located in one of the first hole, the second hole, and the opening hole.
